(19) United States
(12) Patent Application Publication
(10) Pub. No.: US 2026/0057706 A1
(43) Pub. Date: Feb. 26, 2026

(54) INFORMATION PROCESSING SYSTEM, INFORMATION PROCESSING METHOD, AND NON-TRANSITORY RECORDING MEDIUM

(71) Applicant: NEC Corporation, Minato-ku, Tokyo (JP)

(72) Inventor: Yoshihiro KAJIKI, Tokyo (JP)

(73) Assignee: NEC Corporation, Minato-ku, Tokyo (JP)

(21) Appl. No.: 19/104,720

(22) PCT Filed: Sep. 8, 2022
(86) PCT No.: PCT/JP2022/033698

§ 371 Date: Feb. 19, 2025

(51) Int. Cl. G06V 40/40; G06K 7/14; G06V 40/16; G06V 40/50

(52) U.S. Cl. CPC G06V 40/40; G06V 40/172; G06V 40/50; G06K 7/1417

(57) ABSTRACT

An information processing system includes: a registration unit that associates and registers biometric identification information capable of identifying a living body, biometric information on a predetermined part of the living body, and wearing item identification information presented by a wearing item worn by the living body, the wearing item identification information being capturable in an image; an acquisition unit that acquires a captured image obtained by capturing the living body wearing the wearing item; a verification unit that verifies the living body by using the wearing item identification information included in the captured image; and a spoofing determination unit that determines whether or not a body other than the living body is impersonating the living body, by using an image of the predetermined part of the living body included in the captured image, in response to a predetermined condition being satisfied.

### TECHNICAL FIELD

This disclosure relates to technical fields of an information processing system, an information processing method, and a recording medium.

### BACKGROUND ART

Patent Literature 1 describes the following technique/technology: a first authentication means performs authentication on the basis of a first authentication method: when the authentication by the first authentication method is successful, a recording means records an authenticated user in association with a location of the user in a storage means: a second authentication means performs authentication on the basis of a second authentication method; and a restriction means restricts a success in the authentication by the second authentication method when a user to be authenticated by the second authentication method and a location of the user to be authenticated are not associated in the storage means.

Patent Literature 2 describes a technique/technology of: at an event in which a game is performed via a game device, accepting a user's participation registration to the event: managing a user's face image to be used for identification of a user and event information that is information to be used for identification of the event: performing face authentication of the user by using the user's face image; and proceeding the event based on a result of the face authentication. Patent Literature 3 describes the following technique/technology: a use license including transaction information defining a use condition of a use object for a user is printed as a two-dimensional code on a ticket: a use management device photographs the two-dimensional code printed on the ticket, and reads the use license from the photographic data: a signature attached to the use license is verified by using a public key previously provided by a provider of the use object; and when signature verification is established, the transaction information included in the use license is referred to, and in a case where the use condition specified by the transaction information is satisfied, use of the use object by a user is permitted.

Patent Literature 4 describes an authentication apparatus including: an image storage section for storing an image including a code and a person: a code authentication section that authenticates the code in the image: a person authentication section that authenticates the person in the image; and an output section that outputs an authentication result, which is information indicating authentication permission, when the authentication result of the code authentication section indicates authentication permission and the authentication result of the person authentication section indicates authentication permission.

### CITATION LIST

### Patent Literature

Patent Literature 1: International Publication No. WO2021/131060
Patent Literature 2: JP2021-164578A
Patent Literature 3: JP2021-135552A
Patent Literature 4: JP2016-018406A

### SUMMARY

It is an example object of this disclosure to provide an information processing system, an information processing method, and a recording medium that aim to improve the techniques/technologies disclosed in Citation List.

### Solution to Problem

An information processing system according to an example aspect includes: a registration unit that associates and registers biometric identification information capable of identifying a living body, biometric information on a predetermined part of the living body, and wearing item identification information presented by a wearing item worn by the living body, the wearing item identification information being capturable in an image: an acquisition unit that acquires a captured image obtained by capturing the living body wearing the wearing item: a verification unit that verifies the living body by using the wearing item identification information included in the captured image; and a spoofing determination unit that determines whether or not a body other than the living body is impersonating the living body, by using an image of the predetermined part of the living body included in the captured image, in response to a predetermined condition being satisfied.

An information processing method according to an example aspect includes: associating and registering biometric identification information capable of identifying a living body, biometric information on a predetermined part of the living body, and wearing item identification information presented by a wearing item worn by the living body, the wearing item identification information being capturable in an image: acquiring a captured image obtained by capturing the living body wearing the wearing item: verifying the living body by using the wearing item identification information included in the captured image; and determining whether or not a body other than the living body is impersonating the living body, by using an image of the predetermined part of the living body included in the captured image, in response to a predetermined condition being satisfied.

A recording medium according to an example aspect is a recording medium on which a computer program that allows a computer to execute an information processing method is recorded, the information processing method including: associating and registering biometric identification information capable of identifying a living body, biometric information on a predetermined part of the living body, and wearing item identification information presented by a wearing item worn by the living body, the wearing item identification information being capturable in an image: acquiring a captured image obtained by capturing the living body wearing the wearing item: verifying the living body by using the wearing item identification information included in the captured image; and determining whether or not a body other than the living body is impersonating the living body, by using an image of the predetermined part of the living body included in the captured image, in response to a predetermined condition being satisfied.

### BRIEF DESCRIPTION OF DRAWINGS

FIG. 1 is a block diagram illustrating a configuration of an information processing system in a first example embodiment.

FIG. 2 is a block diagram illustrating a configuration of an information processing system in a second example embodiment.

FIG. 3 is a diagram illustrating an example of a scene of the information processing system in the second example embodiment.

FIG. 4 is a flowchart illustrating a flow of a registration operation of the information processing system in the second example embodiment.

FIG. 5 is a diagram illustrating an example of a scene of the information processing system in the second example embodiment.

FIG. 6 is a flowchart illustrating a flow of a verification operation of the information processing system in the second example embodiment.

FIG. 7 is a diagram illustrating an example of a scene of an information processing system in a third example embodiment.

FIG. 8 is a block diagram illustrating a configuration of an information processing system in a sixth example embodiment.

FIG. 9 is a flowchart illustrating a flow of a verification operation of the information processing system in the sixth example embodiment.

FIG. 10 is a diagram illustrating an example of a scene of an information processing system in a seventh example embodiment.

FIG. 11 is a block diagram illustrating a configuration of the information processing system in the seventh example embodiment.

FIG. 12 is a flowchart illustrating a flow of a verification operation of the information processing system in the seventh example embodiment.

### DESCRIPTION OF EXAMPLE EMBODIMENTS

Hereinafter, with reference to the drawings, an information processing system, an information processing method, and a recording medium according to example embodiments will be described.

### 1: First Example Embodiment

An information processing system, an information processing method, and a recording medium according to a first example embodiment will be described. The following describes the information processing system, the information processing method, and the recording medium according to the first example embodiment, by using an information processing system S1 to which the information processing system, the information processing method, and the recording medium according to the first example embodiment are applied.

### 1-1: Configuration of Information Processing System S1

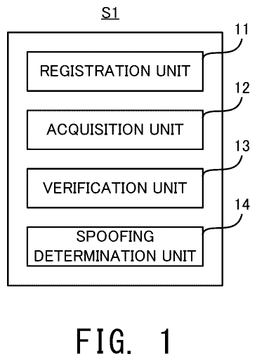

FIG. 1 is a block diagram illustrating a configuration of the information processing system S1 in the first example embodiment. As illustrated in FIG. 1, the information processing system S1 includes a registration unit 11, an acquisition unit 12, a verification unit 13, and a spoofing determination unit 14.

The registration unit 11 associates and registers biometric identification information capable of identifying a living body, biometric information on a predetermined part of the living body; and wearing item identification information presented by a wearing item worn by the living body: The wearing item identification information is information that may be captured in an image. The acquisition unit 12 acquires a captured image obtained by capturing the living body wearing the wearing item. The verification unit 13 verifies the living body by using the wearing item identification information included in the captured image. The spoofing determination unit 14 determines whether or not a body other than the living body is impersonating the living body, by using an image of the predetermined part of the living body included in the captured image, in response to a predetermined condition being satisfied.

### 1-2: Technical Effect of Information Processing System S1

The information processing system S1 in the first example embodiment verifies the living body by the verification using the wearing item identification information, and performs a spoofing determination operation using the biometric information, in response to a predetermined condition being satisfied. It is thus possible to prevent spoofing/impersonation. Even if the spoofing is performed, the spoofing is detectable.

### 2: Second Example Embodiment

Next, an information processing system, an information processing method, and a recording medium according to a second example embodiment will be described. The following describes the information processing system, the information processing method, and the recording medium according to the second example embodiment, by using an information processing system S2 to which the information processing system, the information processing method, and the recording medium according to the second example embodiment are applied.

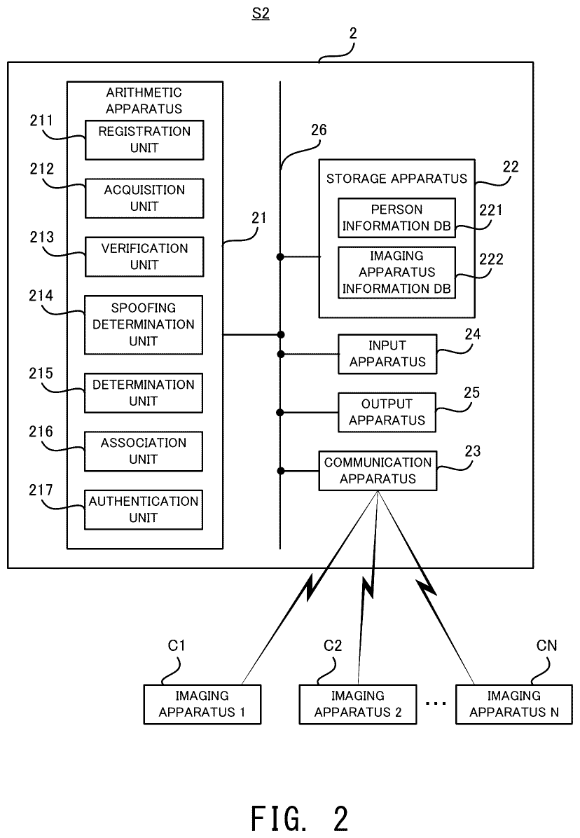

FIG. 2 is a block diagram of the information processing system S2 in the second example embodiment. As illustrated in FIG. 2, the information processing system S2 in the second example embodiment may include a plurality of imaging apparatuses C (i.e., an imaging apparatus C1, an imaging apparatus C2, . . . , and an imaging apparatus CN) and an information processing apparatus 2.

### 2-1: Configuration of Information Processing Apparatus 2

As illustrated in FIG. 2, the information processing apparatus 2 includes an arithmetic apparatus 21 and a storage apparatus 22. Furthermore, the information processing apparatus 2 may include a communication apparatus 23, an input apparatus 24, and an output apparatus 25. The information processing apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 2 (e.g., the input apparatus 24 described later). The arithmetic apparatus 21 may acquire (i.e., download or read) a computer program from a not-illustrated apparatus disposed outside the information processing apparatus 2 via the communication apparatus 23 (or another communication apparatus). The arithmetic apparatus 21 executes the read computer program. Consequently: a logical functional block for performing an operation to be performed by the information processing apparatus 2 is realized or implemented in the arithmetic apparatus 21. That is, the arithmetic apparatus 21 is allowed to function as a controller for realizing or implementing the logical functional block for performing an operation (in other words, processing) to be performed by the information processing apparatus 2.

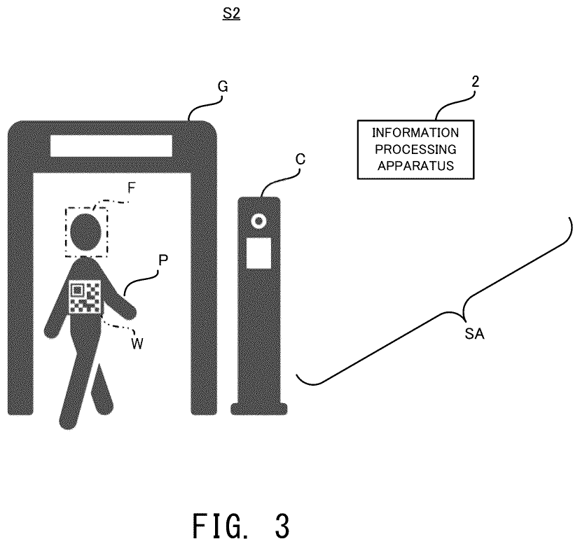

FIG. 2 illustrates an example of the logical functional block realized or implemented in the arithmetic apparatus 21 to perform an information processing operation. As illustrated in FIG. 2, a registration unit 211 that is a specific example of the “registration unit” described in Supplementary Note later, an acquisition unit 212 that is a specific example of the “acquisition unit” described in Supplementary Note later, a verification unit 213 that is a specific example of the “verification unit” described in Supplementary Note later, a spoofing determination unit 214 that is a specific example of the “spoofing determination unit” described in Supplementary Note later, a determination unit 215 that is a specific example of the “determination unit” described in Supplementary Note later, an association unit 216, and an authentication unit 217, are realized or implemented in the arithmetic apparatus 21. The arithmetic apparatus 21, however, may not include at least one of the determination unit 215, the associated unit 216, and the authentication unit 217. Detailed operation of each of the registration unit 211, the acquisition unit 212, the verification unit 213, the spoofing determination unit 214, the determination unit 215, the association unit 216, and the authentication unit 217 will be described in detail later with reference to FIG. 3 to FIG. 6. Table 1, and Table 2.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information processing apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium. The storage apparatus 22 may include a person information database 221. In the second example embodiment, the person information database 221 may be a database that associates at least biometric identification information capable of identifying a living body, biometric information on a predetermined part of the living body, and wearing item identification information presented by a wearing item worn by the living body, the wearing item identification information being capturable in an image. The person information database 221 will be described with reference to Table 1. The storage apparatus 22, however, may not include the person information database 221. In this instance, the person information database 221 may be realized in another apparatus. The storage apparatus 22 may also include an imaging apparatus information database 222. In the second example embodiment, the imaging apparatus information database 222 may be a database in which the imaging apparatus C is associated with information indicating whether or not a captured image captured by the imaging apparatus C is used for a spoofing determination operation. The imaging apparatus information database 222 will be described with reference to Table2. The storage apparatus 22, however, may not include the imaging apparatus information database 222. In this instance, the imaging apparatus information database 222 may be realized in another apparatus.

The communication apparatus 23 is configured to communicate with an apparatus external to the information processing apparatus 2 via a not-illustrated communication network. The information processing apparatus 2 may transmit and receive signals to and from the plurality of imaging apparatuses C via the communication apparatus 23.

The input apparatus 24 is an apparatus that receives an input of information to the information processing apparatus 2 from an outside of the information processing apparatus 2. For example, the input apparatus 24 may include an operating apparatus (e.g., at least one of a keyboard, a mouse, and a touch panel) that is operable by an operator of the information processing apparatus 2. For example, the input apparatus 24 may include a reading apparatus that is configured to read information recorded as data on a recording medium that is externally attachable to the information processing apparatus 2.

The output apparatus 25 is an apparatus that outputs information to the outside of the information processing apparatus 2. For example, the output apparatus 25 may output the information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) that is configured to print desired information on the paper surface.

### 2-2: Registration Operation Performed by Information Processing System S2

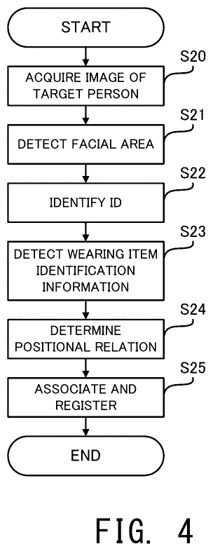

Next, with reference to FIG. 3, FIG. 4, and Table 1, a registration operation performed by the information processing system S2 in the second example embodiment will be described. FIG. 3 is a conceptual diagram of the information processing system S2 at the time of the registration operation in the second example embodiment. FIG. 4 is a flowchart illustrating a flow of the registration operation performed by the information processing system S2 in the second example embodiment.

As illustrated in FIG. 3, in the second example embodiment, the living body may be a person. The person who is a target of the registration operation is also referred to as a target person P. In the second example embodiment, a facial area F may be adopted as the predetermined part of the living body to identify the target person P. Furthermore, the wearing item may be an outerwear worn by the target person P. A code image W serving as the wearing item identification information may be added to the outerwear. The code image W serving as the wearing item identification information may be printed on the outerwear.

The information processing system S2 may perform the registration operation, for example, when there is the target person P at an entrance G of a specific area SA. The imaging apparatus C that captures the target person P may be provided near the entrance G. For example, the entrance G may be a building entrance. In the second example embodiment, verification of the target person P using the code image W (hereinafter sometimes referred to as “code verification”) and biometric authentication are used at the entrance G, and the code image W of the target person P may be registered. In the second example embodiment, the registration operation may be an operation of temporal association, such as from entrance to exit from the specific area SA on a day: The registration operation may be an operation performed when the target person P puts on the outerwear. For example, the target person P may put on the outerwear to which the code image W is added, near the entrance G.

As illustrated in FIG. 4, the acquisition unit 212 acquires a captured image obtained by capturing the target person P wearing the outerwear as the wearing item (step S20). The acquisition unit 212 may acquire an image captured by the imaging apparatus C via the communication apparatus 23.

The association unit 216 detects the facial area F included in the captured image (step S21). The authentication unit 217 performs face authentication and identifies an ID serving as the biometric identification information on the target person P (step S22). For example, in the storage apparatus 22, the ID serving as the biometric identification information and feature information on the facial area F serving as the biometric information may be associated with each other and registered in advance. The authentication unit 217 may perform face authentication by using the pieces of information registered in advance.

The association unit 216 detects the code image W added to the outerwear worn by the target person P included in the captured image (step S23). The association unit 216 performs determination using a position of the detected facial area F and a position of the detected code image W (step S24). For example, the association unit 216 may determine whether the position of the facial area F and the position of the code image W are in a natural positional relation. The association unit 216 may determine that the target person P subjected to face authentication is the same person as the target person P wearing the outerwear to which the code image W is added, based on the position of the facial area F and the position of the code image W.

The registration unit 211 associates and registers the biometric identification information capable of identifying the target person P, facial feature information (also referred to as a “facial feature quantity”) serving as the biometric information on the predetermined part of the target person P, and information indicated by the code image W presented by the outerwear worn by the target person P (step S25). The registration unit 211 may register the associated pieces of information in the person information database 221 illustrated in Table 1 below.

TABLE 1
[Person Information Database 221]

| | Biometric | Wearing Item |
|---|---|---|
| ID | Information | Information |
| A | AA | aa |
| B | BB | bb |
| C | CC | cc |

For example, the registration unit 211 may associate and register an ID “A”, a facial feature quantity “AA” of the target person P with the ID “A”, and information “aa” indicated by the code image W presented by the outerwear worn by the target person P. In addition, the registration unit 211 may associate and register an ID “B”, a facial feature quantity “BB” of the target person P with the ID “B”, and information “bb” indicated by the code image W presented by the outerwear worn by the target person P. In addition, the registration unit 211 may associate and register an ID “C”, a facial feature quantity “CC” of target person P whose ID is “C” and the information “cc” indicated by the code image W presented by the outerwear worn by the target person P.

### 2-3: Verification and Spoofing Determination Operation Performed by Information Processing System S2

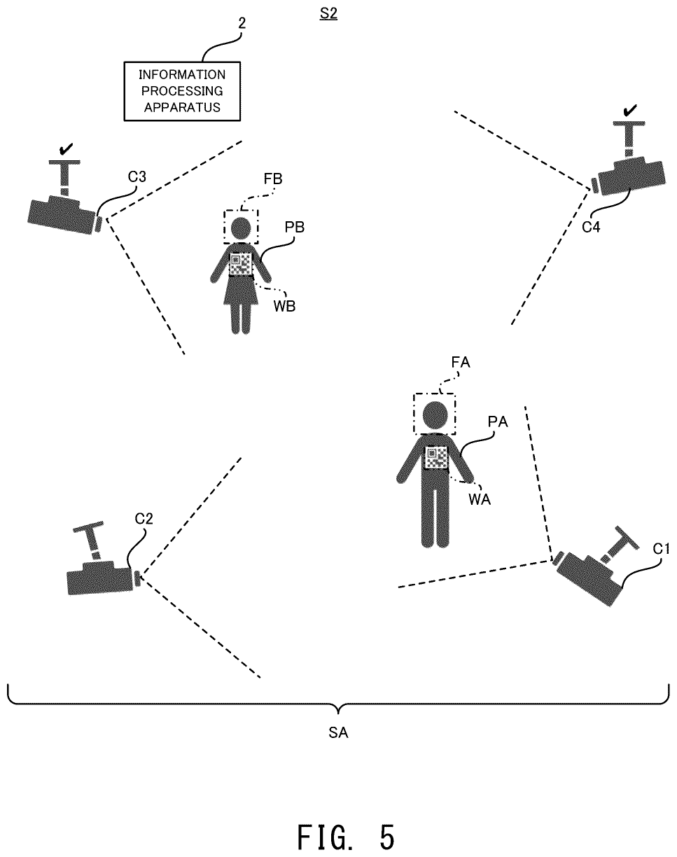

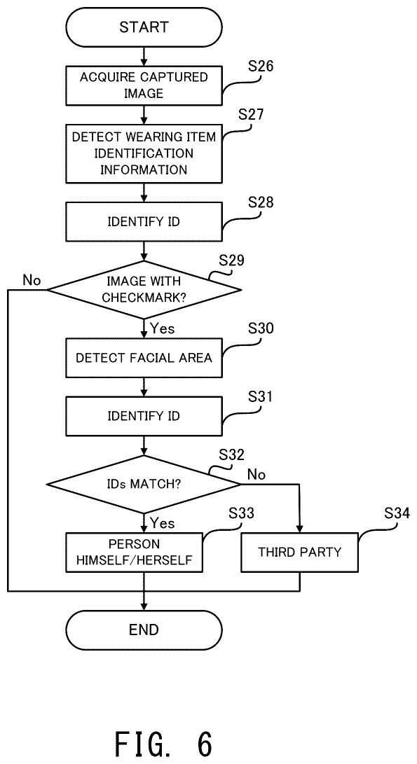

Next, with reference to FIG. 5, FIG. 6, and Table 2, a verification operation and a spoofing determination operation performed by the information processing system S2 in the second example embodiment will be described. FIG. 5 is a conceptual diagram of the information processing system S2 at the time of the verification operation and the spoofing determination operation in the second example embodiment. FIG. 6 is a flowchart illustrating a flow of the verification operation and the spoofing determination operation performed by the information processing system S2 in the second example embodiment.

FIG. 5 illustrates a case where an imaging apparatus C1, an imaging apparatus C2, an imaging apparatus C3, and an imaging apparatus C4 (referred to as an imaging apparatus C when there is no need to distinguish them) are provided in the specific area SA. Each imaging apparatus C may capture a predetermined space, by being disposed such that the predetermined space is captured, in order to capture the target person P. Each imaging apparatus C may be disposed at a height of 2.5 meters, for example. In a case where the imaging apparatus C is disposed higher than an average person's height, the image captured by the imaging apparatus C is likely to include a facial area of the target person P and an upper body area of the target person P, as well as a whole body area of the target person P. Therefore, the imaging apparatus C easily captures an image including the facial area F and the code image W of the target person P. Each imaging apparatus C may have a different image capture range. Each imaging apparatus C may be disposed to have a different image capture range. In the case illustrated in FIG. 5, the image capture range of the imaging apparatus C1 includes a target person PA, and an image captured by the imaging apparatus C1 may include a facial area FA and a code image WA of the target person PA. In addition, the image capture range of the imaging apparatus C3 includes a target person PB, and an image captured by the imaging apparatus C3 may include a facial area FB and a code image WB of the target person PB.

The determination unit 215 determines whether or not the spoofing determination unit 214 performs spoofing determination by using the captured image captured by a corresponding imaging apparatus C, for each of the plurality of imaging apparatuses C. The determination unit 215 may store a determination result for each imaging apparatus C, in the imaging apparatus information database 222 illustrated in Table 2 below.

TABLE 2
[Imaging Apparatus Information Database 222]

| CAMERA ID | CHECK |
|---|---|
| C1 | |
| C2 | |
| C3 | ✓ |
| C4 | ✓ |

As illustrated in Table 2, in a case where the determination unit 215 determines that the spoofing determination is to be performed by using a captured image captured by a certain imaging apparatus C, a checkmark may be placed in a column of the corresponding imaging apparatus C. That is, in the case illustrated in Table 2, the determination unit 215 determines that the spoofing determination is to be performed by using the captured images captured by the imaging apparatus C3 and the imaging apparatus C4. To the captured image captured by the imaging apparatus C with a checkmark placed, information indicating that a checkmark is placed, may be added.

The acquisition unit 212 acquires the captured image from each of the plurality of imaging apparatuses C, but the operation from “start” to “end” illustrated in FIG. 6 may be an operation regarding the captured image acquired from any of the imaging apparatuses C. In addition, the operation from “start” to “end” illustrated in FIG. 6 may be an operation regarding one image. For example, in a case where the imaging apparatus C captures a video, the operation from “start” to “end” illustrated in FIG. 6 may be an operation for each frame.

As illustrated in FIG. 6, the acquisition unit 212 acquires the captured image obtained by capturing the target person P wearing the outerwear to which the code image W is added (step S26). The association unit 216 detects the code image W included in the captured image (step S27). The verification unit 213 verifies the target person P by using the code image W and identifies an ID of the target person P (step S28).

The spoofing determination unit 214 determines whether or not a checkmark is placed in the captured image (step S29). The captured image with a checkmark placed may be the captured image captured by the imaging apparatus C with a checkmark placed. That is, the spoofing determination unit 214 determines whether or not corresponding captured image is an image to be used for the spoofing determination. A case where the captured image is the image to be used for the spoofing determination, may be an aspect of a case where the predetermined condition is satisfied. Alternatively, the case where the predetermined condition is satisfied, may be a case where the target person P is captured in a captured image captured by a predetermined imaging apparatus C.

The association unit 216 detects the facial area F included in the captured image (step S30). The authentication unit 217 performs face authentication and identifies an ID serving as the biometric identification information on the target person P (step S31).

The spoofing determination unit 214 determines whether or not the ID identified in the step S28 matches the ID identified in the step S31 (step S32). When the captured image includes a plurality of target persons P, the spoofing determination unit 214 may determine whether or not the ID identified from the facial area F matches the ID identified from the code image W regarding which the association unit 216 determine that the target person P subjected to face authentication is the same person as the target person P wearing the outerwear to which the code image W is added, based on the position of the facial area F and the position of the code image W.

When the IDs match (the step S32: Yes), the spoofing determination unit 214 determines that an other than the person himself/herself is not impersonating the person himself/herself (step S33). When the IDs do not match (the step S32: No), the spoofing determination unit 214 determines that an other than the person himself/herself is impersonating the person himself/herself (step S34). That is, the spoofing determination unit 214 determines whether or not a person other than the target person P is impersonating the target person P by using the facial area F of the target person P identified by the verification of the code image W.

Alternatively, a case where the IDs do not match (the step S32: No) may be, for example, a case where it is possible to identify the ID by the facial area F, and may be a case where it is hardly possible to identify the ID by the code image W. The case where it is hardly possible to identify the ID by the code image W, corresponds to a case where the code image W is turned over and is hardly captured in the image, or similar cases, for example. In this instance, the information processing apparatus 2 may notify the corresponding target person P of information indicating that the code image W is to be visible. For example, the information processing apparatus 2 may transmit information indicating that the code image W is not likely to be captured in the image, to a portable information terminal carried by the target person P.

In the above example embodiment, the facial feature information is exemplified as the biometric information, but the biometric information may be iris feature information, and iris authentication may be used to identify an individual and to perform the spoofing determination.

The information processing system S2 may also be applied at a site where biometric authentication such as face authentication cannot be applied, such as when wearing protective suits.

### 2-4: Technical Effect of Information Processing System S2

The image used for the code verification is usable for an intended purpose, even when its image quality is lower than that of the image used for biometric authentication such as face authentication. Therefore, even an overhead image captured from a distance, a rear, and a side by a surveillance camera or the like, is usable for the code verification using a code such as the code image W described above. That is, even the image including an unclear facial area F, is usable for the code verification. In addition, since the code verification has a relatively smaller computer processing amount and a smaller processing load than those of biometric authentication using the biometric information, it is possible to identify an individual in a short time. Since the code verification makes it possible to identify an individual at high speed, it is also possible to track a person at a high frame rate, thereby improving the accuracy of person behavior tracking.

On the other hand, in the code verification in the second example embodiment, in a case where the wearing item is lent, lost, stolen, or duplicated, another person may impersonate the person himself/herself. In contrast, the information processing system S2 in the second example embodiment determines whether or not a person other than the person himself/herself is impersonating the person himself/herself by using the biometric information, in response to the predetermined condition being satisfied. Therefore, it is possible to perform authentication as reliable as the biometric authentication.

The verification of the biometric information has a larger computer processing amount than that of the code verification. Thus, if the spoofing determination is performed all the times, the computer processing amount becomes very large. In contrast, since the information processing system S2 performs the spoofing determination, in response to a predetermined condition being satisfied, it is possible to reduce the processing load. Especially in the second example embodiment, the information processing system S2 determines whether or not to perform the spoofing determination by using the captured image captured by the imaging apparatus C, for each imaging apparatus C. It is therefore possible to reduce the computer processing amount to reduce a facility cost regarding a computer facility; to reduce an electric power used by a computer, and to reduce carbon dioxide emissions regarding global warming.

In addition, for example, in a case where the information processing system S2 is applied in a company; it is unlikely that an employee, who is the target person P, wears another person's wearing item to impersonate the other. Thus, even if the spoofing determination is performed only when required, it has little impact on reliability of the individual identification by the code verification.

### 3: Third Example Embodiment

Next, an information processing system, an information processing method, and a recording medium according to a third example embodiment will be described. The following describes the information processing system, the information processing method, and the recording medium according to the third example embodiment, by using an information processing system S3 to which the information processing system, the information processing method, and the recording medium according to the third example embodiment are applied.

### 3-1: Configuration of Information Processing System S3

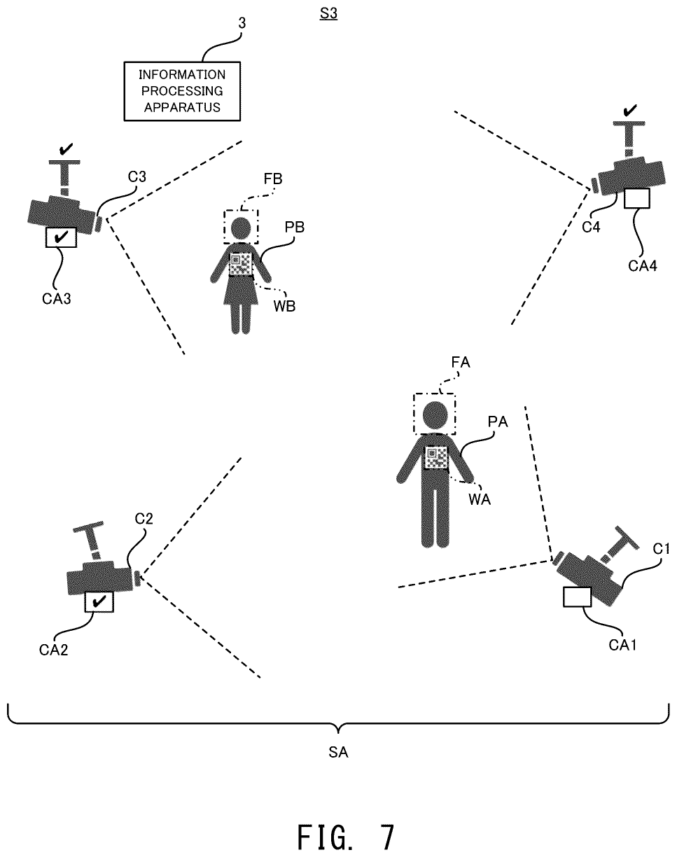

With reference to FIG. 7, a configuration of the information processing system S3 in the third example embodiment will be described. FIG. 7 is a block diagram illustrating the configuration of the information processing system S3 in the third example embodiment. As illustrated in FIG. 7, the information processing system S3 in the third example embodiment may include a plurality of imaging apparatuses C and an information processing apparatus 3, as in the information processing system S2 in the second example embodiment. The information processing apparatus in the third example embodiment may have the same configuration as that of the information processing apparatus 2 in the second example embodiment.

In the third example embodiment, each of the plurality of imaging apparatuses C includes a notification unit CA that notifies the target person P whether or not the captured image captured by the corresponding imaging apparatus C is used for the spoofing determination, independently of the determination by the determination unit 215. The notification unit CA may notify an authentication subject as if the spoofing determination were performed. That is, the notification unit CA may give notice even when the spoofing determination is not performed.

In the case illustrated in FIG. 7, in the imaging apparatus C1, the captured image is not used for the spoofing determination, and a notification unit CA1 does not notify the target person P that the captured image is used for the spoofing determination. In the imaging apparatus C2, the captured image is not used for the spoofing determination, but a notification unit CA2 notifies the target person P that the captured image is used for the spoofing determination. In the imaging apparatus C3, the captured image is used for the spoofing determination, and a notification unit CA3 notifies the target person P that the captured image is used for the spoofing determination. In the imaging apparatus C4, the captured image is used for the spoofing determination, but a notification unit CA4 does not notify the target person P that the captured image is used for the spoofing determination.

### 3-2: Technical Effect of Information Processing System S3

If it is known that there is a case where the spoofing determination is not performed, a malicious person may commit fraud by spoofing/impersonation, aiming at a place or a time zone in which the spoofing determination is not performed. In contrast, since the imaging apparatus C in the third example embodiment includes the notification unit CA that gives notice as if the spoofing determination were performed, the target person P cannot accurately recognize which imaging apparatus C provides the captured image to be used for the spoofing determination. The information processing system S3 makes it possible to prevent a malicious person from committing fraud by the spoofing.

### 4: Fourth Example Embodiment

Next, an information processing system, an information processing method, and a recording medium according to a fourth example embodiment will be described. The following describes the information processing system, the information processing method, and the recording medium according to the fourth example embodiment, by using an information processing system to which the information processing system, the information processing method, and the recording medium according to the fourth example embodiment are applied.

The information processing system in the fourth example embodiment may have the same configuration as that of the information processing system S2 in the second example embodiment or the information processing system S3 in the third example embodiment. The information processing system in the fourth example embodiment is different from the information processing system S2 in the second example embodiment and the information processing system S3 in the third example embodiment, in a determination operation by the determination unit 215.

### 4-1: Information Processing Operation Performed by Information Processing System

The determination unit 215 dynamically changes the determination of whether or not the spoofing determination is to be performed by using the captured image captured by the imaging apparatus C. The determination unit 215 changes setting of whether or not it is necessary to perform the spoofing determination, during execution of the verification operation and the spoofing determination operation. For example, the determination unit 215 may change the setting from setting details illustrated in Table 3 to setting details illustrated in Table 4 below.

TABLE 3
[Imaging Apparatus Information Database 222 Before Change]

| | | ON OFF |
|---|---|---|
| CAMERA ID | CHECK | TIME POINT |
| C1 | | 10:10 |
| C2 | | 10:05 |
| C3 | ✓ | 10:05 |
| C4 | ✓ | 10:10 |

TABLE 4
[Imaging Apparatus Information Database 222 After Change]

| | | ON OFF |
|---|---|---|
| CAMERA ID | CHECK | TIME POINT |
| C1 | | 10:10 |
| C2 | ✓ | 10:15 |
| C3 | | 10:15 |
| C4 | ✓ | 10:10 |

That is, in the cases illustrated in Table 3 and Table 4, at 10:15, the determination unit 215 removes a checkmark placed in the imaging apparatus C3 and places a checkmark in the imaging apparatus C2. That is, the determination unit 215 makes such a change that the captured image captured by the imaging apparatus C3 is not used for the spoofing determination, but the captured image captured by the imaging apparatus C2 is used for the spoofing determination.

### 4-2: Technical Effect of Information Processing System

If it is fixed which imaging apparatus C provides the captured image to be used for the spoofing determination, the spoofing performed by a malicious person may be missed. In contrast, since the information processing system in the fourth example embodiment dynamically changes the determination of which imaging apparatus C provides the captured image to be used for the spoofing determination, it is possible to reduce that the spoofing is missed.

### 5: Fifth Example Embodiment

An information processing system, an information processing method, and a recording medium according to a fifth example embodiment will be described. The following describes the information processing system, the information processing method, and the recording medium according to the fifth example embodiment, by using an information processing system S5 to which the information processing system, the information processing method, and the recording medium according to the fifth example embodiment are applied.

### 5-1: Configuration of Information Processing System S5

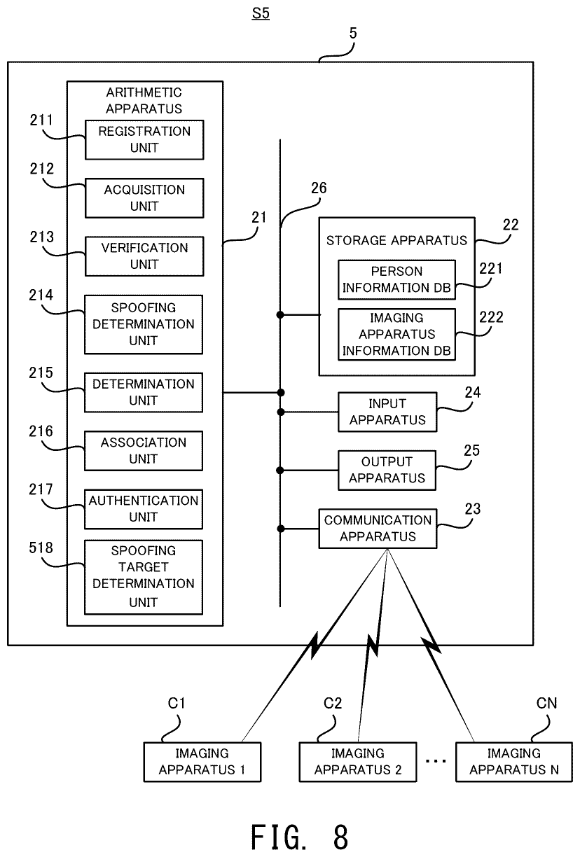

With reference to FIG. 8, a configuration of the information processing system S5 in the fifth example embodiment will be described. FIG. 8 is a block diagram illustrating the configuration of the information processing system S5 in the fifth example embodiment. As illustrated in FIG. 8, the information processing system S5 in the fifth example embodiment may include a plurality of imaging apparatuses C and an information processing apparatus 5, as in at least one of the information processing system S2 in the second example embodiment to the information processing system in the fourth example embodiment.

As illustrated in FIG. 8, the information processing apparatus 5 in the fifth example embodiment includes the arithmetic apparatus 21 and the storage apparatus 22, as in the information processing apparatus 2 in the second example embodiment to the information processing apparatus in the fourth example embodiment. Furthermore, the information processing apparatus 5 in the fifth example embodiment may include the communication apparatus 23, the input apparatus 24, and the output apparatus 25, as in the information processing apparatus 2 in the second example embodiment to the information processing apparatus in the fourth example embodiment. The information processing apparatus 5, however, may not include at least one of the communication apparatus 23, the input apparatus 24, and the output apparatus 25. The information processing apparatus 5 in the fifth example embodiment is different from the information processing apparatus 2 in the second example embodiment to the information processing apparatus in the fourth example embodiment, in that the arithmetic apparatus 21 further includes a spoofing target determination unit 518. Other features of the information processing apparatus 5 may be the same as those of at least one of the information processing apparatus 2 in the second example embodiment to the information processing apparatus in the fourth example embodiment. For this reason, a part that is different from each of the example embodiments described above will be described in detail below, and a description of the other overlapping parts will be omitted as appropriate.

### 5-2: Information Processing Operation Performed by Information Processing System S5

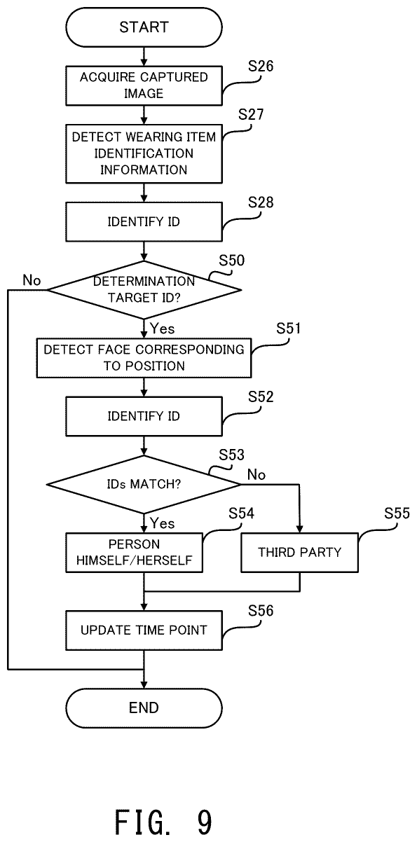

With reference to FIG. 9, an information processing operation performed by the information processing system S5 in the fifth example embodiment will be described. FIG. 9 is a flowchart illustrating a flow of the information processing operation performed by the information processing system S5 in the fifth example embodiment. As illustrated in FIG. 9, the operation after an ID serving as the biometric identification information on the target person P is identified by the code verification using the code image W in the step S28, is different from the information processing operation in the second example embodiment illustrated in the flowchart in FIG. 6.

The spoofing target determination unit 518 determines whether or not the target person P, who is the living body, is a target of the spoofing determination by the spoofing determination unit 214 (step S50). The spoofing target determination unit 518 may determine whether or not the target person P is a target of the spoofing determination by the spoofing determination unit 214, with reference to the person information database 221 illustrated in Table5 below.

TABLE 5
[Person Information Database 221 Before Update]

| | | | SPOOFING |
|---|---|---|---|
| | BIOMETRIC | WEARING ITEM | DETERMINATION |
| ID | INFORMATION | INFORMATION | TIME POINT |
| A | AA | aa | 10:10 |
| B | BB | bb | 10:15 |
| C | CC | cc | 10:13 |

In the fifth example embodiment, the spoofing target determination unit 518 determines that target person P is a target of the spoofing determination by the spoofing determination unit 214 forming a target person P, in a case where a predetermined time elapses after the target person P is determined by the spoofing determination unit 214. For example, as illustrated in Table 5, when information indicated by the code image WA is “aa,” the ID of the target person PA is identified as “A.” As illustrated in Table 5, for the target person PA with the ID “A”, a previous spoofing determination time point is 10:10. For example, a case where the predetermined time is 5 minutes and a current time point is 10:16, corresponds to a case where the predetermined time elapses after the target person P is determined by the spoofing determination unit 214.

In a case where the predetermined time elapses after the target person P is determined by the spoofing determination unit 214 (the step S50: Yes), the association unit 216 detects the facial area F corresponding to the position of the code image W (step S51).

The authentication unit 217 performs face authentication and identifies an ID serving as the biometric identification information on the target person P (step S52). The spoofing determination unit 214 determines whether or not the ID identified in the step S28 matches the ID specified in the step S52 (step S53). When the IDs match (the step S53: Yes), the spoofing determination unit 214 determines that a person other than the person himself/herself is not impersonating the person himself/herself (step S54). When the IDs do not match (the step S53: No), the spoofing determination unit 214 determines that a person other than the person himself/herself is impersonating the person himself/herself (step S55).

The spoofing target determination unit 518 updates the time point of the person information database 221 (step S56). For example, in a case of the spoofing determination for the target person PA with the ID “A”, the spoofing determination time point of the registration unit 211 may be updated from “10:10” illustrated in Table 5 to “10:16” illustrated in Table 6 below.

TABLE 6
[Person Information Database 221 After Update]

| | | | SPOOFING |
|---|---|---|---|
| | BIOMETRIC | WEARING ITEM | DETERMINATION |
| ID | INFORMATION | INFORMATION | TIME POINT |
| A | AA | aa | 10:16 |
| B | BB | bb | 10:15 |
| C | CC | cc | 10:13 |

The case where the predetermined condition is satisfied in the fifth example embodiment, may be a case where a predetermined target person P is captured in the captured image.

Furthermore, the case where the predetermined condition is satisfied in the fifth example embodiment, may be a case where the target person P is captured in the captured image captured by the predetermined imaging apparatus C as in the second example embodiment, and a case where the target person P is a target of the spoofing determination.

The spoofing determination may be performed on the target person P, depending on a condition such as the number of the target persons P captured in the captured image, in addition to the fact that the spoofing determination is not performed for the predetermined time or more. For example, when a large number of target persons P are targets of the spoofing determination, the number of the imaging apparatuses C that capture the images used for the spoofing determination, may be reduced. On the contrary, when a small number of target persons P are targets of the spoofing determination, the number of the imaging apparatuses C that capture the images used for the spoofing determination, may be increased. The number of the target persons P who are targets of the spoofing determination and the number of the imaging apparatuses C that capture the images used for the spoofing determination, may be adjusted depending on a processing amount of the spoofing determination.

### 5-3: Technical Effect of Information Processing System S5

Since the information processing system S5 in the fifth example embodiment is configured to determine whether or not each target person P is a target of the spoofing determination, it is possible to reduce unnecessary spoofing determination, thereby reducing a processing load. In particular, the target persons P is determined to be a target of the spoofing determination in a case where the predetermined time elapses after the spoofing determination is performed, it is possible to perform necessary spoofing determination. A possibility of the spoofing is likely to be high in a case where the predetermined time elapses after the spoofing determination is performed. It is therefore possible to suitably prevent the spoofing, by setting the target person P for whom the predetermined time elapses after the spoofing determination, to be a target of the spoofing determination.

### 6: Sixth Example Embodiment

An information processing system, an information processing method, and a recording medium according to a sixth example embodiment will be described. The following describes the information processing system, the information processing method, and the recording medium according to the sixth example embodiment, by using an information processing system S6 to which the information processing system, the information processing method, and the recording medium according to the sixth example embodiment are applied.

### 6-1: Configuration of Information Processing System S6

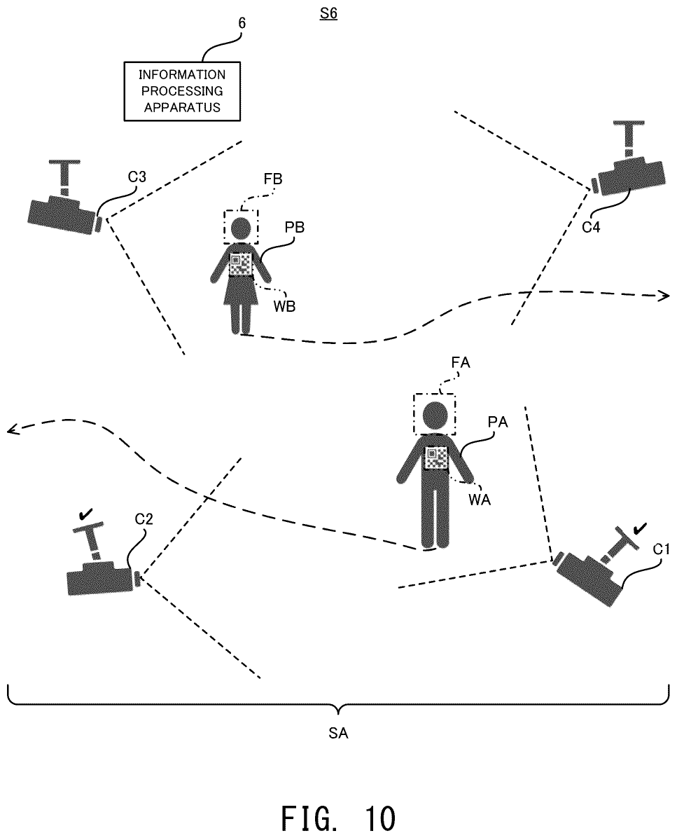

With reference to FIG. 10, a configuration of the information processing system S6 in the sixth example embodiment will be described. FIG. 10 is a block diagram illustrating the configuration of the information processing system S6 in the sixth example embodiment. As illustrated in FIG. 10, the information processing system S6 in the sixth example embodiment may include a plurality of imaging apparatuses C and an information processing apparatus 6, as in at least one of the information processing system S2 in the second example embodiment to the information processing system S5 in the fifth example embodiment.

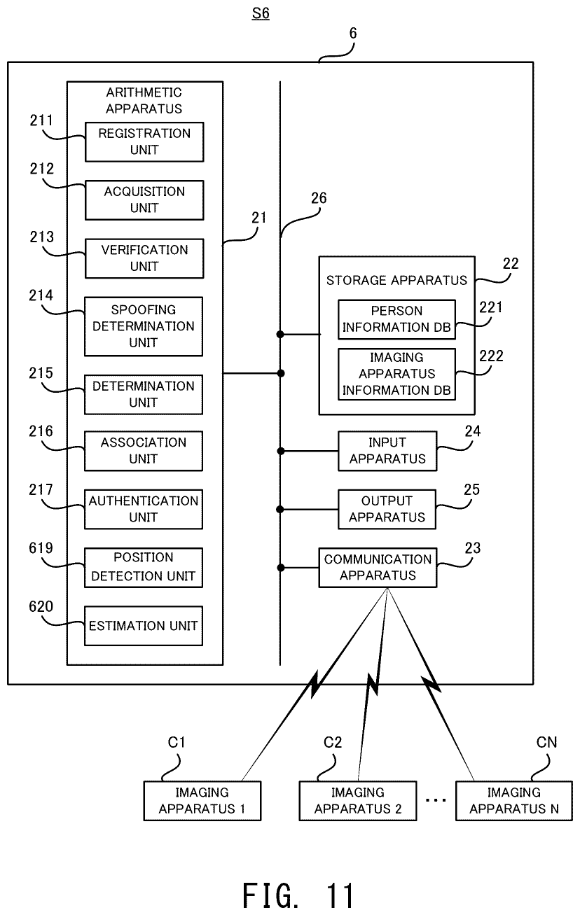

As illustrated in FIG. 11, the information processing apparatus 6 in the sixth example embodiment includes the arithmetic apparatus 21 and the storage apparatus 22, as in the information processing apparatus 2 in the second example embodiment to the information processing apparatus 5 in the fifth example embodiment. Furthermore, the information processing apparatus 6 in the sixth example embodiment may include the communication apparatus 23, the input apparatus 24, and the output apparatus 25, as in the information processing apparatus 2 in the second example embodiment to the information processing apparatus 5 in the fifth example embodiment. The information processing apparatus 6, however, may not include at least one of the communication apparatus 23, the input apparatus 24, and the output apparatus 25. The information processing apparatus 6 in the sixth example embodiment is different from the information processing apparatus 2 in the second example embodiment to the information processing apparatus 5 in the fifth example embodiment, in that the arithmetic apparatus 21 further includes a position detection unit 619 and an estimation unit 620. Other features of the information processing apparatus 6 may be the same as those of at least one of the information processing apparatus 2 in the second example embodiment to the information processing apparatus 5 in the fifth example embodiment. For this reason, a part that is different from each of the example embodiments described above will be described in detail below; and a description of the other overlapping parts will be omitted as appropriate.

### 6-2: Information Processing Operation Performed by Information Processing System S6

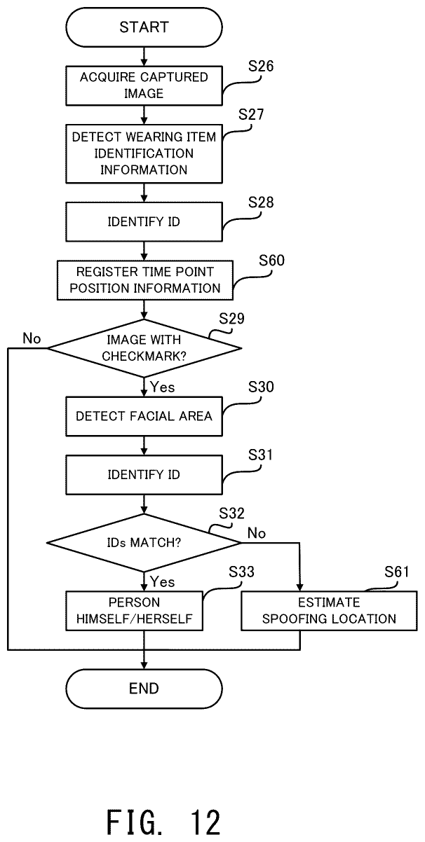

With reference to FIG. 12, an information processing operation performed by the information processing system S6 in the sixth example embodiment will be described. FIG. 12 is a flowchart illustrating a flow of the information processing operation performed by the information processing system S6 in the sixth example embodiment. As illustrated in FIG. 12, the operation after an ID is identified in the step S28 and the operation when the IDs do not match in the step S32, are differ from the information processing operation in the second example embodiment illustrated in the flowchart in FIG. 6.

After the ID is identified in the step S28, the position detection unit 619 detects a location of the target person P wearing the outerwear to which the code image W is added, based on a verification result by the verification unit 213. The position detection unit 619 may identify the location of the target person P by using the code image W. Since the code image W has obvious dimensions and shapes, the position detection unit 619 is able to measure a three-dimensional depth and direction of the target person P, by using the code image W. Furthermore, the position detection unit 619 may analyze behavior and posture of the target person P from the three-dimensional depth and angle. The position detection unit 619 registers information indicating the position of the target person P at the time of the code verification, in the person information database 221 (step S60). In the sixth example embodiment, the person information database 221 may include time point position information on the target person P as illustrated in Table7 below. The time point position information on the target person P registered in the person information database 221 may be information to be accumulated. The time point position information on the target person P registered in the person information database 221 may be information that is not deleted until a particular condition, such as a lapse of the predetermined time, is satisfied.

TABLE 7
[Person Information Database 221]

| | | WEARING | SPOOFING | TIME POINT |
|---|---|---|---|---|
| | BIOMETRIC | ITEM | DETERMINATION | POSITION |
| ID | INFORMATION | INFORMATION | TIME POINT | INFORMATION |
| A | AA | aa | 10:16 | 10:17 = IN FRONT OF |
| | | | | CABINET . . . |
| B | BB | bb | 10:15 | 10:14 = IN FRONT OF |
| | | | | MULTI-FUNCTION |
| | | | | PRINTER . . . |
| C | CC | cc | 10:13 | 10:15 = IN FRONT |
| | | | | CHANGING ROOM . . . |

In the step S32, when the IDs do not match (the step S32: No), the spoofing determination unit 214 determines that a person other than the person himself/herself is impersonating the person himself/herself. When the spoofing determination unit 214 determines that a person other than the person himself/herself is impersonating the person himself/herself, the estimation unit 620 refers to the information registered in the person information database 221 and estimates in which location a person other than the person himself/herself is impersonating the person himself/herself (step S61). According to the information illustrated in Table 7, the estimation unit 620 is allowed to refer to the information indicating that the target person PA is in front of a cabinet at least at 10:17, from the previous spoofing determination, i.e., 10:16, until a current time.

The estimation unit 620 is able to know the location of the target person P during a period from the previous spoofing determination to the current spoofing determination, from the information stored in the person information database 221. That is, in a case where the spoofing determination is determined to be performed as a result of the spoofing determination, the position of the spoofing determination is estimated by tracing a history of authentication.

### 6-3: Technical Effect of Information Processing System S6

Since the information processing system S6 in the sixth example embodiment is configured to estimate in which location a person other than the person himself/herself is impersonating the person himself/herself, it is possible to recognize in which location the spoofing determination needs to be performed.

In addition, the information processing system S6 is configured to track the target person P and grasp behavior, based on the information stored in the person information database 221. The information processing system S6 uses the verification of the code image W and the face authentication, to maintain a legal trail of behavior records with reliability of the biometric authentication. The information processing system S6 can be applied to acquire a legal audit trail such as evidence of working by a qualified person.

### 7: Seventh Example Embodiment

Next, an information processing system, an information processing method, and a recording medium according to a seventh example embodiment will be described. The following describes the information processing system, the information processing method, and the recording medium according to the seventh example embodiment, by using an information processing system to which the information processing system, the information processing method, and the recording medium according to the seventh example embodiment are applied.

The information processing system in the seventh example embodiment may have the same configuration as that of at least one of the information processing system S2 in the second example embodiment to the information processing system S6 in the sixth example embodiment. The information processing system in the seventh example embodiment is different from the information processing system S2 in the second example embodiment to the information processing system S6 in the sixth example embodiment, in the determination operation by the determination unit 215.

### 7-1: Information Processing Operation by Information Processing System

The determination unit 215 determines that the spotting determination is to be performed by using the captured image captured by the imaging apparatus C that captures a location with a high possibility of occurrence of the spoofing. When there are a plurality of imaging apparatuses C, the determination unit 215 selects and sets an imaging apparatus C that is set to perform the spoofing determination, depending on a degree of importance of the tracking and the personal authentication. For example, in the sixth example embodiment, the imaging apparatus C that captures the location estimated by the estimation unit 620, is estimated to be the imaging apparatus C that captures the location with a high possibility of occurrence of the spoofing. The determination unit 215 may determine that the spotting determination is to be performed by using the captured image captured by the imaging apparatus C.

### 7-2: Technical Effect of Information Processing System

The information processing system in the seventh example embodiment is configured to reduce/prevent the occurrence of the spoofing, such as lending a code to others, by performing the biometric authentication at important positions, such as a place where people are likely to be replaced, like a changing room or a toilet.

### 8: Supplementary Notes

With respect to the example embodiment described above, the following Supplementary Notes are further disclosed.

### Supplementary Note 1

An information processing system including:
a registration unit that associates and registers biometric identification information capable of identifying a living body, biometric information on a predetermined part of the living body, and wearing item identification information presented by a wearing item worn by the living body, the wearing item identification information being capturable in an image:
an acquisition unit that acquires a captured image obtained by capturing the living body wearing the wearing item:
a verification unit that verifies the living body by using the wearing item identification information included in the captured image; and
a spoofing determination unit that determines whether or not a body other than the living body is impersonating the living body, by using an image of the predetermined part of the living body included in the captured image, in response to a predetermined condition being satisfied.

### Supplementary Note 2

The information processing system according to Supplementary Note 1, wherein
the acquisition unit acquires the captured image from each of a plurality of imaging units, and
the information processing system further includes a determination unit that determines whether or not the spoofing determination unit performs spoofing determination by using the captured image captured by a corresponding imaging unit, for each of the plurality of imaging units.

### Supplementary Note 3

The information processing system according to Supplementary Note 2, wherein each of the plurality of imaging units includes a notification unit that notifies the living body whether or not the captured image captured by the corresponding imaging apparatus is used for the spoofing determination, independently of determination by the determination unit.

### Supplementary Note 4

The information processing system according to Supplementary Note 2 or 3, wherein the determination unit dynamically changes determination of whether or not the spoofing determination is to be performed by using the captured image captured by the imaging unit.

### Supplementary Note 5

The information processing system according to any of Supplementary Notes 2 to 4, wherein the determination unit determines that the spoofing determination is to be performed by using the captured image captured by the imaging unit that captures a location with a high possibility of occurrence of spoofing.

### Supplementary Note 6

The information processing system according to any of Supplementary Notes 1 to 5, further including a spoofing target determination unit that determines whether or not the living body is a target of spoofing determination by the spoofing determination unit.

### Supplementary Note 7

The information processing system according to Supplementary Note 6, wherein the spoofing target determination unit determines that the living body is a target of the spoofing determination by the spoofing determination unit, in a case where a predetermined time elapses after the living body is determined by the spoofing determination unit.

### Supplementary Note 8

The information processing system according to any of Supplementary Notes 1 to 7, further including an estimation unit that detects a location of the living body wearing the wearing item based on a verification result by the verification unit, and estimates in which location the body other than the living body is impersonating the living body, in response to the spoofing determination unit determining that the body other than the living body is impersonating the living body:

### Supplementary Note 9

An information processing method including:
associating and registering biometric identification information capable of identifying a living body, biometric information on a predetermined part of the living body, and wearing item identification information presented by a wearing item worn by the living body, the wearing item identification information being capturable in an image:
acquiring a captured image obtained by capturing the living body wearing the wearing item:
verifying the living body by using the wearing item identification information included in the captured image; and
determining whether or not a body other than the living body is impersonating the living body, by using an image of the predetermined part of the living body included in the captured image, in response to a predetermined condition being satisfied.

### Supplementary Note 10

A recording medium on which a computer program that allows a computer to execute an information processing method is recorded, the information processing method including:
associating and registering biometric identification information capable of identifying a living body, biometric information on a predetermined part of the living body, and wearing item identification information presented by a wearing item worn by the living body, the wearing item identification information being capturable in an image:
acquiring a captured image obtained by capturing the living body wearing the wearing item:
verifying the living body by using the wearing item identification information included in the captured image; and
determining whether or not a body other than the living body is impersonating the living body, by using an image of the predetermined part of the living body included in the captured image, in response to a predetermined condition being satisfied.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, the disclosures of all documents (e.g., publications) cited in this disclosure above are incorporated into a part of the description of this disclosure.

This disclosure is not limited to the examples described above. This disclosure is allowed to be changed, if desired, without departing from the essence or spirit of this disclosure which can be read from the claims and the entire identification. An information processing apparatus, an information processing method, and a recording medium with such changes are also intended to be within the technical scope of this disclosure.

### DESCRIPTION OF REFERENCE CODES

S1, S2, S3, S5, S6 Information processing system
2, 3, 5, 6 Information processing apparatus
11, 211 Registration unit
12, 212 Acquisition unit
13, 213 Verification unit
14, 214 Spoofing determination unit
215 Determination unit
216 Association unit
217 Authentication unit
518 Spoofing target determination unit
619 Position detection unit
620 Estimation unit
221 Person information database
222 Imaging apparatus information database
C Imaging apparatus
CA Notification unit
F Facial area
W Code image

What is claimed is:

1. An information processing system comprising:
at least one memory that is configured to store instructions; and
at least one processor that is configured to execute the instructions to:
associate and register biometric identification information capable of identifying a living body, biometric information on a predetermined part of the living body, and wearing item identification information presented by a wearing item worn by the living body, the wearing item identification information being capturable in an image;
acquire a captured image obtained by capturing the living body wearing the wearing item;
verify the living body by using the wearing item identification information included in the captured image; and
determine whether or not a body other than the living body is impersonating the living body, by using an image of the predetermined part of the living body included in the captured image, in response to a predetermined condition being satisfied.

2. The information processing system according to claim 1, wherein the at least one processor is configured to execute the instructions to:
acquire the captured image from each of a plurality of imaging units, and
determine whether or not spoofing determination is to be performed by using the captured image captured by a corresponding imaging unit, for each of the plurality of imaging units.

3. The information processing system according to claim 2, wherein each of the plurality of imaging units includes a notification unit that notifies the living body whether or not the captured image captured by the corresponding imaging unit is used for the spoofing determination, independently of determination.

4. The information processing system according to claim 2, wherein the at least one processor is configured to execute the instructions to dynamically change determination of whether or not the spoofing determination is to be performed by using the captured image captured by the imaging unit.

5. The information processing system according to claim 2, wherein the at least one processor is configured to execute the instructions to determine that the spoofing determination is to be performed by using the captured image captured by the imaging unit that captures a location with a high possibility of occurrence of spoofing.

6. The information processing system according to claim 1, wherein the at least one processor is configured to execute the instructions to determine whether or not the living body is a target of spoofing determination.

7. The information processing system according to claim 6, wherein the at least one processor is configured to execute the instructions to determine that the living body is a target of the spoofing determination, in a case where a predetermined time elapses after the living body is determined.

8. The information processing system according to claim 1, wherein the at least one processor is configured to execute the instructions to detect a location of the living body wearing the wearing item based on a verification result, and estimates in which location the body other than the living body is impersonating the living body, in response to determining that the body other than the living body is impersonating the living body.

9. An information processing method comprising:
associating and registering biometric identification information capable of identifying a living body, biometric information on a predetermined part of the living body, and wearing item identification information presented by a wearing item worn by the living body, the wearing item identification information being capturable in an image;
acquiring a captured image obtained by capturing the living body wearing the wearing item;
verifying the living body by using the wearing item identification information included in the captured image; and
determining whether or not a body other than the living body is impersonating the living body, by using an image of the predetermined part of the living body included in the captured image, in response to a predetermined condition being satisfied.

10. A non-transitory recording medium on which a computer program that allows a computer to execute an information processing method is recorded, the information processing method including:
associating and registering biometric identification information capable of identifying a living body, biometric information on a predetermined part of the living body, and wearing item identification information presented by a wearing item worn by the living body, the wearing item identification information being capturable in an image;
acquiring a captured image obtained by capturing the living body wearing the wearing item;
verifying the living body by using the wearing item identification information included in the captured image; and
determining whether or not a body other than the living body is impersonating the living body, by using an image of the predetermined part of the living body included in the captured image, in response to a predetermined condition being satisfied.
